(19) United States
(12) Patent Application Publication
(10) Pub. No.: US 2025/0110088 A1
(43) Pub. Date: Apr. 3, 2025

(54) Ultrasonic Apparatus

(71) Applicant: SEIKO EPSON CORPORATION, Tokyo (JP)

(72) Inventors: Osamu MURAYAMA, Yamagata (JP); Yoshio ARAI, Shiojiri (JP)

(21) Appl. No.: 18/897,360

(22) Filed: Sep. 26, 2024

(30) Foreign Application Priority Data
Sep. 29, 2023 (JP) 2023-169238

(51) Int. Cl. G01N 29/24; G01N 29/04; G01N 29/32

(52) U.S. Cl. CPC G01N 29/2481; G01N 29/04; G01N 29/32

(57) ABSTRACT

An ultrasonic apparatus includes an ultrasonic sensor transmitting and receiving ultrasonic waves and outputting an ultrasonic signal corresponding to the received ultrasonic wave, a circuit coupled to the ultrasonic sensor and processes the ultrasonic signal input from the ultrasonic sensor to generate a reception signal, a wireless communicator coupled to the circuit and converting the reception signal into an electromagnetic wave and transmits the electromagnetic wave to an external device, a casing housing the ultrasonic sensor, the circuit, and the wireless communicator, and an electromagnetic shield disposed between the ultrasonic sensor and the wireless communicator in the casing and shielding the electromagnetic wave.

The present application is based on, and claims priority from JP Application Serial Number 2023-169238, filed Sep. 29, 2023, the disclosure of which is hereby incorporated by reference herein in its entirety.

### BACKGROUND

### 1. Technical Field

The present disclosure relates to an ultrasonic apparatus.

### 2. Related Art

In related art, a wireless communication-type ultrasonic measurement apparatus that transmits and receives signals to and from an external device via wireless communication is known as an ultrasonic apparatus that transmits and receives ultrasonic waves (for example, see JP-A-2011-072583).

In the ultrasonic apparatus described in JP-A-2011-072583, a detection signal based on the received ultrasonic wave output from an ultrasonic transducer array is modulated into a radio wave, and transmitted from a wireless communicator to an ultrasonic observer.

JP-A-2011-072583 is an example of the related art.

In the ultrasonic apparatus that communicates with an external device via wireless communication as in JP-A-2011-072583, operability is better because a cable line is unnecessary and an influence of external noise due to use of a long cable line is lower. However, there is a problem that electromagnetic noise is generated with wireless communication in the wireless communicator and adversely affects an ultrasonic signal output from the ultrasonic transducer.

### SUMMARY

An ultrasonic apparatus according to a first aspect of the present disclosure includes an ultrasonic sensor transmitting and receiving ultrasonic waves and outputting an ultrasonic signal corresponding to the received ultrasonic wave, a circuit coupled to the ultrasonic sensor and processes the ultrasonic signal input from the ultrasonic sensor to generate a reception signal, a wireless communicator coupled to the circuit and converting the reception signal into an electromagnetic wave and transmits the electromagnetic wave to an external device, a casing housing the ultrasonic sensor, the circuit, and the wireless communicator, and a shielding portion disposed between the ultrasonic sensor and the wireless communicator in the casing and shielding the electromagnetic wave.

### BRIEF DESCRIPTION OF THE DRAWINGS

FIG. 1 is a sectional view showing a schematic configuration of an ultrasonic apparatus according to a first embodiment.

FIG. 2 is a schematic plan view when an upper case is removed in the ultrasonic apparatus of the first embodiment.

FIG. 3 is a schematic plan view showing an example of an ultrasonic sensor according to the first embodiment.

FIG. 4 is a schematic sectional view of the ultrasonic sensor taken cut along line B-B in FIG. 3.

FIG. 5 is a block diagram of the ultrasonic apparatus according to the first embodiment.

FIG. 6 is a block diagram of the ultrasonic apparatus according to the second embodiment.

### DESCRIPTION OF EMBODIMENTS

### First Embodiment

As below, an ultrasonic apparatus according to a first embodiment of the present disclosure will be described.

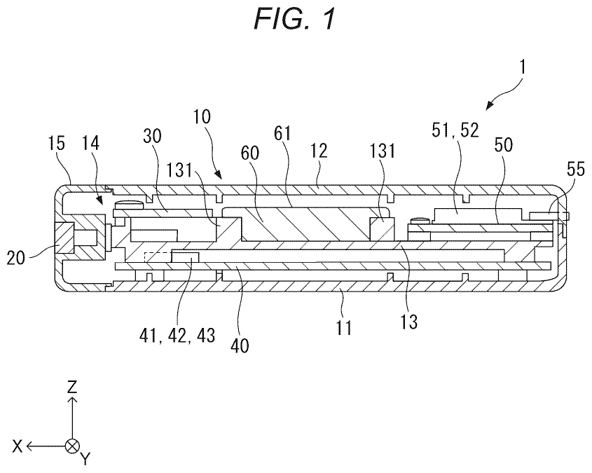

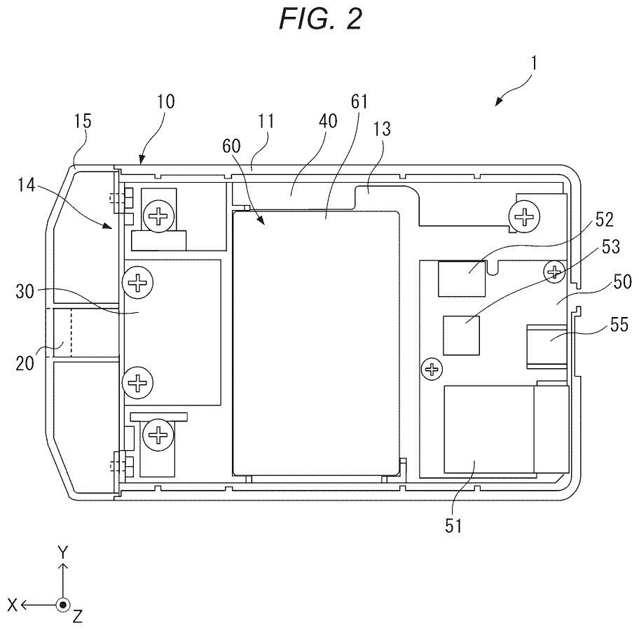

FIG. 1 is a sectional view showing a schematic configuration of an ultrasonic apparatus 1 of the embodiment. FIG. 2 is a plan view when an upper case 12 of the ultrasonic apparatus 1 of the embodiment is removed.

As shown in FIG. 1, the ultrasonic apparatus 1 of the embodiment includes a casing 10, an ultrasonic sensor 20, a relay board 30, a circuit board 40, a wireless communication board 50 (wireless communicator), and a battery 60. The casing 10 includes a lower case 11, the upper case 12, a support 13 disposed between the lower case 11 and the upper case 12, and a sensor case 15.

In the following description, a thickness direction of the ultrasonic apparatus 1 from the lower case 11 toward the upper case 12 is referred to as “Z direction”. Further, a direction orthogonal to the Z direction from the wireless communication board 50 toward the ultrasonic sensor 20 is referred to as “X direction”, and a direction orthogonal to the X direction and the Z direction from a lower side to an upper side in FIG. 2 is referred to as “Y direction”.

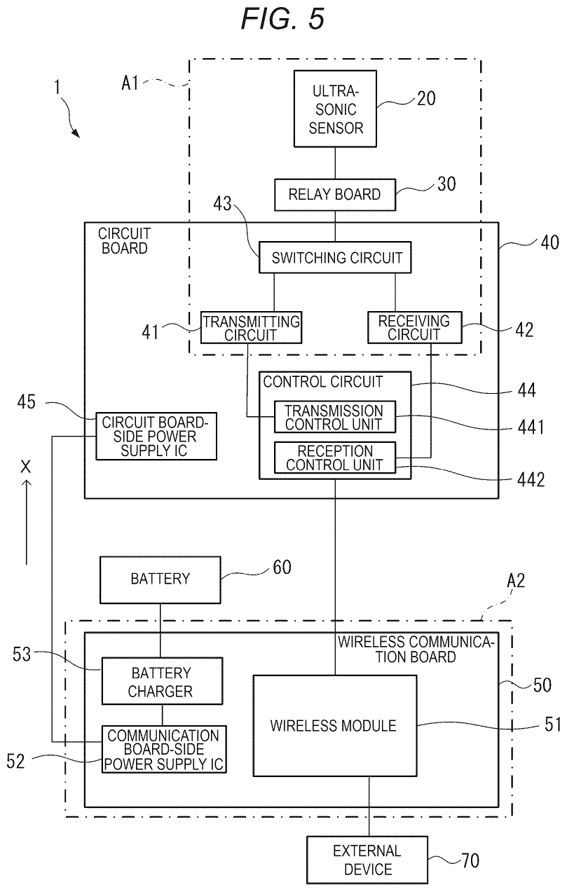

The ultrasonic apparatus 1 of the embodiment can perform wireless communication with an external device 70 (see FIG. 5) via a wireless module 51 provided on the wireless communication board 50. Although a specific configuration of the external device 70 in the present disclosure is omitted, a general computer such as a smartphone, a tablet terminal, or a personal computer may be used as the external device 70. The external device 70 receives a reception signal or the like transmitted from the ultrasonic apparatus 1 and performs various kinds of processing. For example, the external device 70 generates an internal tomographic image of an object to be measured, calculates a thickness of a predetermined part inside the object to be measured, and checks an operation state of the predetermined part of the object to be measured based on the reception signal.

### Configuration of Ultrasonic Sensor 20

The ultrasonic sensor 20 is a sensor that transmits and receives ultrasonic waves and disposed at one end (+X side) of the ultrasonic apparatus 1.

The ultrasonic sensor 20 transmits an ultrasonic wave to an object to be measured and receives the ultrasonic wave reflected by the object to be measured. The ultrasonic sensor 20 is not particularly limited as long as the sensor can transmit and receive ultrasonic waves. For example, a bulk-type ultrasonic element that transmits an ultrasonic wave by applying a voltage to a piezoelectric material to vibrate the piezoelectric material itself and detects reflected wave using an ultrasonic signal output by distortion of the piezoelectric material itself due to the reflected wave may be used. Alternatively, a thin-film ultrasonic element in which a plurality of ultrasonic transducers with piezoelectric elements placed in thin-film vibrating portions are arranged in an array form and the respective vibrating portions are vibrated to transmit ultrasonic waves by application of voltages to the piezoelectric elements may be used.

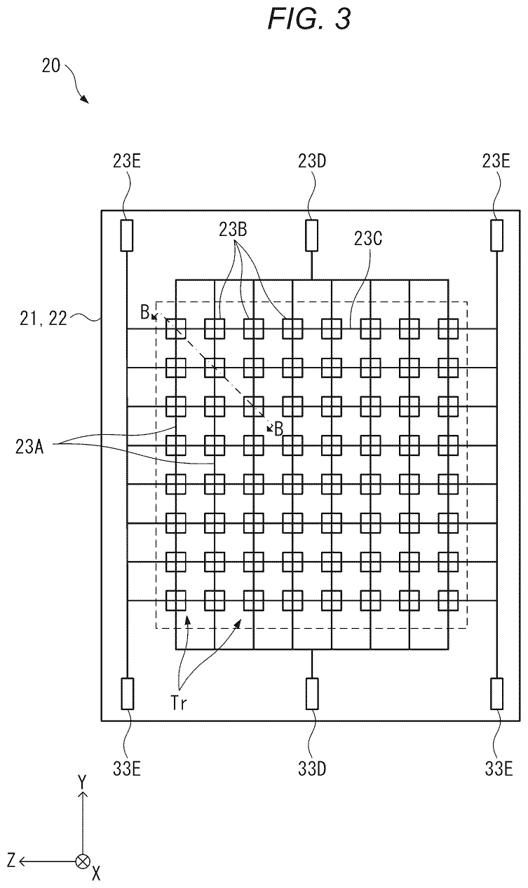

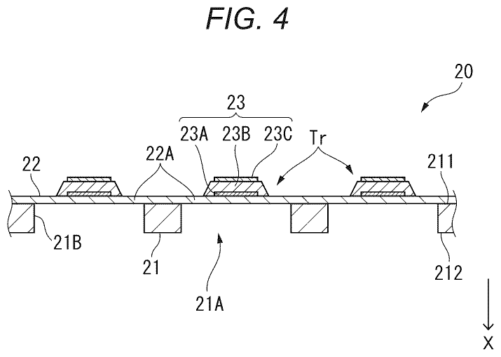

In the embodiment, a thin-film ultrasonic element is used as the ultrasonic sensor 20. FIG. 3 is a schematic plan view showing an example of the ultrasonic sensor 20 of the embodiment. FIG. 4 is a schematic sectional view of the ultrasonic sensor 20 cut along line B-B in FIG. 3.

In the ultrasonic sensor 20, a plurality of ultrasonic transducers Tr are arranged in a two-dimensional array along the Y direction and the Z direction.

Although the number of the arranged ultrasonic transducers Tr is reduced in FIG. 3 for convenience of description, actually, more ultrasonic transducers Tr may be arranged.

As shown in FIG. 4, the ultrasonic sensor 20 includes an element substrate 21, a vibrating plate 22 provided on the element substrate 21, and piezoelectric elements 23 provided on the vibrating plate 22.

The element substrate 21 includes a semiconductor substrate of Si or the like. The element substrate 21 includes a first surface 211 on the −X side and a second surface 212 on the +X side as a back surface with respect to the first surface 211 as a front surface. The element substrate 21 is provided with a substrate opening 21A that opens from the first surface 211 to the second surface 212 to correspond to each of the ultrasonic transducers Tr. In the embodiment, each substrate opening 21A is a through hole penetrating in a substrate thickness direction (X direction) of the element substrate 21, and the vibrating plate 22 is provided on the −X side of the through hole.

On the side (+X side) of the substrate opening 21A where the vibrating plate 22 is not provided, an acoustic matching material having acoustic impedance close to the object to be measured (for example, living body) may be filled. As the acoustic matching material, for example, a resin material such as silicone may be used. Further, an acoustic lens may be provided on the side (+X side) of the substrate opening 21A where the vibrating plate 22 is not provided. In this case, an acoustic matching material having acoustic impedance close to that of the acoustic lens is filled between the acoustic lens and the vibrating plate 22.

The vibrating plate 22 includes, for example, a stacked structure of SiO₂ and Zro₂, and is provided to cover the entire of the element substrate 21 at the −X side. That is, the vibrating plate 22 is supported by a partition wall 21B forming the substrate opening 21A and closes the −X side of the substrate opening 21A. A thickness dimension of the vibrating plate 22 is sufficiently smaller than that of the element substrate 21.

The piezoelectric elements 23 are respectively provided on the vibrating plate 22 that closes the respective substrate openings 21A. The piezoelectric element 23 includes, for example, a stacked structure formed by stacking of a first electrode 23A, a piezoelectric layer 23B, and a second electrode 23C from the vibrating plate 22 toward the −X side.

Here, a portion of the vibration plate 22 that closes the substrate opening 21A forms a vibrating portion 22A, and the vibrating portion 22A and the piezoelectric element 23 form the single ultrasonic transducer Tr.

In the ultrasonic transducer Tr, when a rectangular wave voltage (drive signal) having a predetermined frequency is applied between the first electrode 23A and the second electrode 23C, the piezoelectric layer 23B is bent, the vibration portion 22A vibrates, and the ultrasonic wave is transmitted to the +X side. When the vibrating portion 22A is vibrated by the ultrasonic wave (reflected wave) reflected by the object to be measured, a potential difference is generated between the upper and lower portions of the piezoelectric layer 23B. Accordingly, the potential difference generated between the first electrode 23A and the second electrode 23C is detected, and thereby, the received ultrasonic wave can be detected.

In the embodiment, as shown in FIG. 3, the first electrodes 23A of the ultrasonic transducers Tr arranged in the Y direction are coupled to one another. These first electrodes 23A are coupled to a drive terminal 23D and electrically coupled from the drive terminal 23D to a control board (not shown) via, for example, a flexible printed-circuit board.

The second electrodes 23C of the ultrasonic transducers Tr arranged in the Z direction are coupled to one another. The second electrodes 23C are coupled to common terminals 23E, and the common terminals 23E are electrically coupled to the control board via, for example, a flexible printed-circuit board.

Here, in the embodiment, with the ultrasonic transducers s Tr arranged in the Y direction as one transmission/reception of set, a plurality transmission/reception sets are arranged in the Z direction. In the embodiment, the respective transmission/reception sets are simultaneously driven, however, the drive terminals 23D independent of each other may be coupled to each of the transmission/reception sets and, in this case, the respective transmission/reception sets can be individually driven. In this case, the drive timings of the respective transmission/reception sets are shifted, and thereby, the ultrasonic waves can be transmitted so that the transmission direction of the ultrasonic waves is changed in a predetermined direction or the ultrasonic waves are focused on a depth of measurement. On the other hand, as shown in FIG. 3, when the respective ultrasonic transducers Tr are coupled to the single drive terminal 23D and simultaneously driven, an acoustic lens is separately provided, and thereby, the ultrasonic waves can be focused on a predetermined depth.

### Configuration of Relay Board 30

Returning to FIGS. 1 and 2, the relay board 30 couples the ultrasonic sensor 20 and the circuit board 40. Although not shown, the relay board 30 includes a terminal portion electrically coupled to the drive terminal 23D and the common terminals 23E provided in the ultrasonic sensor 20, and a wiring circuit for coupling the terminal portion to the circuit board 40.

For the coupling between the relay board 30 and the ultrasonic sensor 20 and the coupling between the relay board 30 and the circuit board 40, a flexible board, a lead wire, or the like (not shown) may be used. Further, the support 13 is disposed between the relay board 30 and the circuit board 40. The relay board 30 and the circuit board 40 may be coupled by fixing of the relay board 30 to the support 13 with a conductive screw and bringing of the conductive screw into contact with or fastening to the terminal portion provided on the circuit board 40.

In the embodiment, the configuration with the relay board 30 is exemplified, however, without the relay board 30, the ultrasonic sensor 20 and the circuit board 40 may be directly coupled by an FPC, a lead wire, or the like.

### Configuration of Circuit Board 40

The circuit board 40 is coupled to the ultrasonic sensor 20 via the relay board 30. The circuit board 40 outputs a drive voltage for transmitting an ultrasonic wave to the ultrasonic sensor 20. The circuit board 40 performs signal processing on the ultrasonic signal input from the ultrasonic sensor 20 to generate a reception signal, and transmits the generated reception signal to an external device via the wireless communication board 50.

FIG. 5 is a block diagram showing a schematic configuration of the ultrasonic apparatus 1 of the embodiment.

More specifically, as shown in FIG. 5, the circuit board 40 of the embodiment includes a transmitting circuit 41, a receiving circuit 42 (signal generator), a switching circuit 43, a control circuit 44, and a circuit board-side power supply IC 45. Although the details will be described later, the circuit board 40 is disposed between the lower case 11 and the support 13 in the casing 10. Here, the ultrasonic sensor 20, the relay board 30, the transmitting circuit 41, the receiving circuit 42, and the switching circuit 43 in the circuit board 40 in a range A1 of FIG. 5 are configured to perform signal transmission by analog signals, and a countermeasure for noise is required. The transmitting circuit 41, the receiving circuit 42, and the switching circuit 43 in the range A1 correspond to a circuit of the present disclosure.

The transmitting circuit 41 generates a drive signal for outputting an ultrasonic wave from the ultrasonic sensor 20, and outputs the drive signal to the ultrasonic sensor 20.

The receiving circuit 42 includes, for example, a denoise circuit, a signal amplifier circuit, an ADC (analog/digital converter), and the like, and performs signal processing on the ultrasonic signal input from the ultrasonic sensor 20 to generate a reception signal. That is, the receiving circuit 42 is a signal generator of the present disclosure, removes noise from an ultrasonic signal, amplifies a signal value of the ultrasonic signal by a predetermined amplification factor, samples the signal value of the ultrasonic signal as an analog signal at a predetermined sampling frequency, and converts the signal value into a reception signal as a digital signal.

The switching circuit 43 can switch between transmission coupling coupling the transmitting circuit 41 and the ultrasonic sensor 20 and reception coupling coupling the receiving circuit 42 and the ultrasonic sensor 20, and switches the coupling state under control of the control circuit 44. When the ultrasonic sensor 20 has a plurality of independent transmission/reception sets, a MUX (multiplexer) that can switch the coupling state with respect to each of the transmission and reception sets may be employed.

The control circuit 44 includes, for example, a semiconductor device such as an FPGA (field programmable gate array). The control circuit 44 functions as, for example, a transmission control unit 441 and a reception control unit 442.

The transmission control unit 441 switches the switching circuit 43 to the transmission coupling according to a start command of ultrasonic measurement, and controls the transmitting circuit 41 to generate and transmit a drive signal at a predetermined drive voltage to the ultrasonic sensor 20. For example, a user may operate the external device 70 to input the start command from the external device 70 to the ultrasound apparatus 1 or an operation button may be provided in the ultrasonic apparatus 1 and the user may operate the operation button to input the start command.

After a predetermined time elapses from the transmission timing of the ultrasonic wave, the reception control unit 442 switches the switching circuit 43 to the reception coupling and controls the receiving circuit 42 to perform signal processing on the ultrasonic signal output from the ultrasonic sensor 20. Thereby, a reception signal is input to the control circuit 44 as a digital signal.

Then, the reception control unit 442 transmits the reception signal input from the receiving circuit 42 to the external device 70 via the wireless communication board 50.

The circuit board-side power supply IC 45 modulates power provided from battery 60 via the communication board-side power supply IC 52 to a voltage at a power supply frequency suitable for the circuit board 40 and the ultrasonic sensor 20, and supplies the voltage to each configuration of the circuit board 40.

The circuit board-side power supply IC 45 is coupled to the communication board-side power supply IC 52 provided on the wireless communication board 50. In the embodiment, the power supplied from the battery 60 is modulated by the communication board-side power supply IC 52, and the power is supplied from the communication board-side power supply IC 52 to the circuit board-side power supply IC 45.

### Configuration of Wireless Communication Board 50

The wireless communication board 50 is coupled to the circuit board 40 and the battery 60.

As will be described in detail later, the wireless communication board 50 is disposed in the casing 10 between the upper case 12 and the support 13 and on the −X side of the battery 60 in the casing 10.

The wireless communication board 50 includes the wireless module 51, the communication board-side power supply IC 52, and a battery charger 53.

The wireless module 51 transmits the reception signal input from the circuit board 40 to the external device 70. The wireless module 51 receives information of, for example, a start command for ultrasonic measurement or the like transmitted from the external device 70, and outputs the information to the control circuit 44 of the circuit board 40.

The communication board-side power supply IC 52 modulates the power supplied from the battery 60 to a voltage at a power supply frequency that can be used for the communication processing in the wireless module 51, and supplies the voltage to the wireless module 51. The communication board-side power supply IC 52 supplies a part of the power supplied from the battery 60 to the circuit board-side power supply IC 45.

Here, the power supply adjustment by the communication board-side power supply IC 52 is performed based on the communication frequency of the electromagnetic wave in wireless communication by the wireless module 51. Thereby, each configuration of the wireless communication board 50 in a range A2 in FIG. 5, particularly, the communication board-side power supply IC 52 for power supply adjustment is a generation source of electromagnetic wave (noise generation source).

The battery charger 53 is a charging circuit that charges the battery 60. The battery charger 53 is coupled to, for example, a connector 55 exposed from the outer surface of the casing 10, and supplies power supplied from a charging cable coupled to the connector 55 to the battery 60 to charge.

### Configuration of Battery 60

The battery 60 is a secondary cell that supplies power to the respective configurations of the ultrasonic apparatus 1. For example, various secondary cells including a lithium-ion battery may be used. In the embodiment, an example of the secondary cell is shown, however, a primary cell may be used as the battery 60.

The battery 60 is supported by the support 13 in the casing 10, and is disposed between the upper case 12 and the support 13 and between the ultrasonic sensor 20 (relay board 30) and the wireless communication board 50.

Generally, the exterior of the battery 60 is covered by a conductive cover 61, and functions as an electromagnetic shield (that is, the shielding portion of the present disclosure).

### Configuration of Casing 10

As described above, the casing 10 includes the lower case 11, the upper case 12, the support 13, and the sensor case 15. The lower case 11 disposed on the −Z side of the ultrasonic apparatus 1 forms an exterior section of the ultrasonic apparatus 1 by engaging with the upper case 12 disposed on the +Z side. With the lower case 11 and the upper case 12 engaged with each other, a case opening 14 is formed at the +X side end of the casing 10, and the sensor case 15 is fixed to close the case opening 14.

The lower case 11, the upper case 12, the support 13, and the sensor case 15 are preferably formed using conductive materials. The conductive material may be, for example, a metal such as aluminum or a conductive resin. The lower case 11, the upper case 12, and the case 15 are formed using conductive materials, and thereby, the ultrasonic sensor 20, the relay board 30, the circuit board 40, and the wireless communication board 50 disposed inside the casing 10 are shielded from external electromagnetic wave.

The support 13 is disposed between the lower case 11 and the upper case 12.

The support 13 includes a battery engagement part 131 facing the upper case 12 and conforming with the outer shape of the battery 60. The battery 60 is fitted in the battery engagement part 131, and thereby, the support 13 supports the battery 60.

The support 13 is formed using a conductive material as described above, and functions as an electromagnetic shield that shields electromagnetic wave between the +Z side (the upper case 12 side) and the −Z side (the lower case 11 side) of the support 13. In the embodiment, the circuit board 40 and the wireless communication board 50 are disposed with the support 13 in between. Thereby, the electromagnetic shield is disposed between the circuit board 40 and the wireless communication board 50, and suppresses the influence of the electromagnetic wave generated in the wireless communication board 50 on the circuit board 40.

In the example shown in FIG. 2, the relay board 30, the circuit board 40, and the wireless communication board 50 are fixed to the support 13 by screws, however, the fixing method of the boards to the casing 10 is not particularly limited. For example, the boards may be fixed using an adhesive or the like, or by engagement of projections provided in the support 13 with holes provided in the respective boards 30, 40, and 50.

Further, in the embodiment, the relay board 30 may be fixed to the upper case 12, the circuit board 40 may be fixed to the lower case 11, or the wireless communication board 50 may be fixed to the upper case 12.

### Arrangement of Each Configuration in Ultrasonic Apparatus 1

Next, the arrangement of the ultrasonic sensor 20, the relay board 30, the circuit board 40, the wireless communication board 50, and the battery 60 in the ultrasonic apparatus 1 will be described.

As described above, the ultrasonic sensor 20 is fixed to the sensor case 15 closing the case opening 14 at the +X side end of the casing 10. The relay board 30 that relays the ultrasonic signal from the ultrasonic sensor 20 to the circuit board 40 is also provided on the +X side of the casing 10.

Further, the circuit board 40 is disposed at the lower case 11 side with the support 13 in between with respect to the relay board 30. In the circuit board 40, the transmitting circuit 41, the receiving circuit 42, and the switching circuit 43 through which the analog signal propagates are disposed on the +X side of the circuit board 40. That is, the transmitting circuit 41, the receiving circuit 42, and the switching circuit 43 are disposed on the −Z side of the relay board 30.

In the ultrasonic apparatus 1, the wireless communication board 50 is disposed on the −X side opposite to the ultrasonic sensor 20 and on the upper case 12 side (+Z side) of the support 13. Further, the battery 60 having the conductive cover 61 and the conductive support 13 including the battery engagement part 131 supporting the battery 60 are disposed between the wireless communication board 50 and the ultrasonic sensor 20 and the relay board 30.

Here, in FIG. 5, as described above, the ultrasonic sensor 20 (the ultrasonic sensor 20, the transmitting circuit 41, the receiving circuit 42, and the switching circuit 43) in the range A1 are configured to perform signal propagation by the analog signals and likely to be affected by electromagnetic wave. Accordingly, a countermeasure for noise is required. On the other hand, the wireless communication board 50 in the range A2 is a noise generation source around the communication board-side power supply IC 52.

In the embodiment, as described above, the configurations in the range A1 are disposed on the +X side in the ultrasonic apparatus 1, and the configurations in the range A2 are disposed on the −X side in the ultrasonic apparatus 1. Thereby, the configurations in the range A1 are disposed apart from the configurations in the range A2 as the noise generation source, and inconvenience that noise generated from the configurations in the range A2 as the noise generation source affects the configurations in the range A1 may be suppressed.

Furthermore, in the embodiment, the battery 60 and the support 13 function as a shielding portion of the present disclosure, and shield electromagnetic waves generated in the configurations in the range A2. Thereby, inconvenience that the electromagnetic wave generated in the wireless communication board 50 affects analog signals of the respective configurations in the range A1 (for example, ultrasonic signals output from the ultrasonic sensor 20) is further suppressed.

Since the reception signal converted into the digital signal by the receiving circuit is not affected by noise, the control circuit 44 and the circuit board-side power supply IC 45 in the circuit board 40 may be disposed on the −X side close to the wireless communication board 50.

### Functions and Effects of Embodiment

The ultrasonic apparatus 1 of the embodiment includes the ultrasonic sensor 20, the transmitting circuit 41, the receiving circuit 42, and the switching circuit 43 forming the circuit, the wireless communication board 50 forming the wireless communicator, and the casing 10. The ultrasonic sensor 20 transmits and receives ultrasonic waves and outputs an ultrasonic signal corresponding to the received ultrasonic wave. The transmitting circuit 41, the receiving circuit 42, and the switching circuit 43 are coupled to the ultrasonic sensor 20 and processes the ultrasonic signal input from the ultrasonic sensor 20 by ultrasonic measurement and generates a reception signal. The wireless communication board 50 is coupled to the circuit board 40 including the circuit, converts the reception signal into electromagnetic wave, and transmits the electromagnetic wave to the external device 70. The casing 10 houses the ultrasonic sensor 20, the circuit board 40, and the wireless communication board 50. In the casing 10, the shielding portion (battery 60 and support 13) shielding the electromagnetic wave is disposed between the ultrasonic sensor 20 and the wireless communication board 50.

Accordingly, the electromagnetic shield is provided between the wireless communication board 50 as a noise generation source and the ultrasonic sensor 20, the transmitting circuit 41, the receiving circuit 42, and the switching circuit 43 in which signal propagation by the analog signals is performed, and thereby, increase of noise due to electromagnetic wave affecting the ultrasonic signal may be suppressed.

In the embodiment, the battery 60 is disposed between the component members in the range A1 including the ultrasonic sensor 20, the transmitting circuit 41, the receiving circuit 42, the switching circuit 43, and the relay board 30 and the component members in the range A2 including the wireless communication board 50. Further, the battery 60 is covered by the conductive cover 61.

Accordingly, the battery 60 functions as the shielding portion of the present disclosure, and the inconvenience that the electromagnetic wave generated in the wireless communication board 50 affects the component members in the range A1 may be suppressed, and thereby, noise may be suppressed. In the ultrasonic apparatus 1 that communicates with the external device 70 by wireless communication without wired coupling to the external device 70, power supply from the external device 70 is difficult. Accordingly, in the ultrasonic apparatus 1, usually, the battery 60 is provided for driving the ultrasonic sensor 20. In the embodiment, the battery 60 functions as a shielding portion (electromagnetic shield), and it is not necessary to separately provide another member forming an electromagnetic shield in the casing 10 and the apparatus 1 can be configuration of the ultrasonic simplified as compared with a configuration with a shielding portion separately provided.

In the embodiment, the casing 10 includes the support 13 having conductivity and supporting the battery 60, and the support 13 functions as the shielding portion.

Accordingly, not only the battery 60 but the support 13 may function as the shielding portion, and thereby, the inconvenience that the electromagnetic wave generated in the wireless communication board 50 affects the component members in the range A1 may be further suppressed. In the ultrasonic apparatus 1 including the battery 60, the support 13 for disposing the battery 60 is usually provided. In the embodiment, the support 13 functions as the shielding portion, and thereby, it is not necessary to separately provide another member forming an electromagnetic shield in the casing 10 and the configuration of the ultrasonic apparatus 1 can be simplified as compared with a configuration with a shielding portion separately provided.

In the embodiment, the lower case 11, the upper case 12, and the sensor case 15 forming the casing 10 also have conductivity.

Accordingly, the ultrasonic sensor 20, the transmitting circuit 41, the receiving circuit 42, the switching circuit 43, and the relay board 30 in the casing 10 can be shielded from external electromagnetic wave and the influence of noise by the external electromagnetic wave can be suppressed.

In the embodiment, the receiving circuit 42 that generates the reception signal from the ultrasonic signal is disposed closer to the ultrasonic sensor 20 than the battery 60 forming the shielding portion. Thereby, the inconvenience that noise is superimposed on the ultrasonic signal may be suppressed and a proper reception signal may be generated.

In the embodiment, the ultrasonic sensor 20 includes the element substrate 21 having the first surface 211 and the second surface 212 and including the substrate opening 21A extending from the first surface 211 to the second surface 212, the vibrating plate 22 disposed to cover the first surface 211 of the element substrate 21, and the piezoelectric element 23 disposed in the position overlapping with the substrate opening 21A as seen from the substrate thickness direction (X direction) from the first surface 211 toward the second surface 212 on the side surface opposite to the element substrate 21 of the vibrating plate 22, and the piezoelectric element 23 is formed by stacking of the first electrode 23A, the piezoelectric layer 23B, and the second electrode 23C along the X direction.

The above described thin-film ultrasonic element is used, and thereby, downsizing of the ultrasonic apparatus 1 may be promoted. Further, in the downsized ultrasonic apparatus 1, particularly, distances between the wireless communication board 50 and the ultrasonic sensor 20 and the respective members forming the circuit are shorter, however, the shielding portion of the battery 60 and the support 13 is provided between the wireless communication board 50 and the respective members forming the circuit and the influence of noise can be suppressed.

### Second Embodiment

Next, a second embodiment will be described.

In the first embodiment, the configuration in which the wireless communication board 50 as the wireless communicator of the present disclosure is provided separately from the circuit board 40 including the transmitting circuit 41, the receiving circuit 42, and the switching circuit 43 forming the circuit of the present disclosure is exemplified. On the other hand, the wireless communicator and the circuit may be disposed on a single substrate.

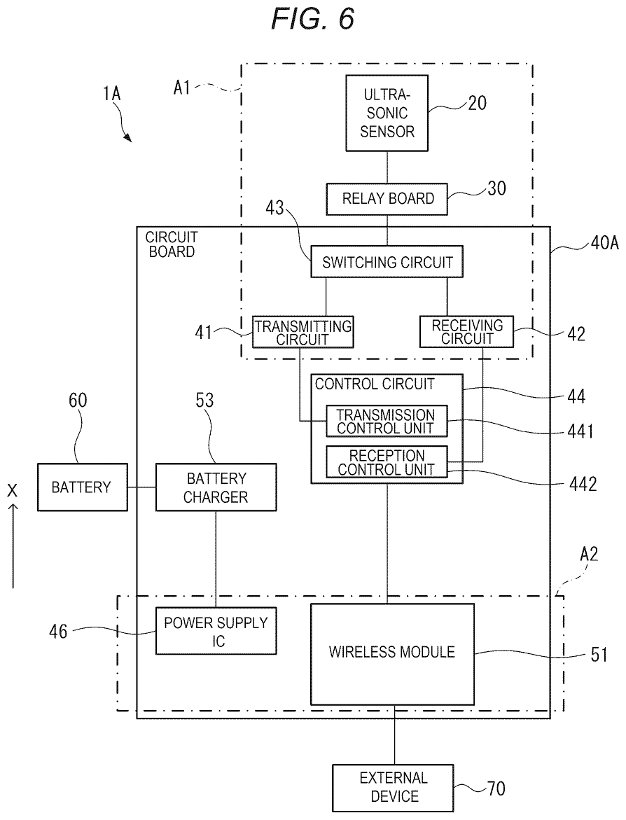

FIG. 6 is a block diagram showing a schematic configuration of an ultrasonic apparatus 1A of the second embodiment. Note that, in the following description, the above described configurations have the same signs and the description thereof is omitted or simplified.

The ultrasonic apparatus 1A of the embodiment includes the casing 10, the ultrasonic sensor 20, the relay board 30, a circuit board 40A, and the battery 60.

The circuit board 40A includes the wireless module 51, the battery charger 53, a power supply IC 46, and the like in addition to the transmitting circuit 41, the receiving circuit 42, the switching circuit 43, the control circuit 44, and the circuit board-side power supply IC 45.

That is, in the embodiment, the circuit board 40 and the wireless communication board 50 of the first embodiment are formed as an integrated board, and the respective circuit configurations are aggregated on the single board.

In the embodiment, the transmitting circuit 41, the receiving circuit 42, and the switching circuit 43 forming the circuit are disposed on the +X side close to the ultrasonic sensor 20 on the circuit board 40A, and the wireless module 51 and the power supply IC 46 forming the wireless communicator as a noise generation source are disposed on the −X side opposite to the ultrasonic sensor 20 on the circuit board 40A.

In the above described embodiment, the respective configurations (the ultrasonic sensor 20, the relay board 30, the transmitting circuit 41, the receiving circuit 42, and the switching circuit 43) in the range A1 in which signal propagation by analog signals is performed and the respective configurations (the wireless module 51 and the power supply IC 46) in the range A2 as the noise generation source are disposed apart from each other. Similarly to the first embodiment, the battery 60 as a shielding portion is disposed between the respective configurations in the range A1 and the respective configurations in the range A2.

Thereby, the same functions and effects as those of the first embodiment may be obtained, and inconvenience that noise increases due to the electromagnetic wave affecting the analog signals such as ultrasonic signals may be suppressed and proper ultrasonic measurement may be performed in the ultrasonic apparatus 1A.

### MODIFIED EXAMPLES

The present disclosure is not limited to the above described respective embodiments. The present disclosure includes modifications, improvements, and configurations obtained by appropriate combination of the respective embodiments within a scope where an object of the present disclosure can be achieved.

### Modified Example 1

In the above described embodiment, the configuration with the relay board 30 is exemplified, however, as described above, the relay board 30 may not be provided. In this case, the ultrasonic sensor 20 may be directly coupled to the circuit board 40.

### Modified Example 2

In the above described embodiment, the example in which the transmitting circuit 41, the receiving circuit 42, and the switching circuit 43 forming the circuit of the present disclosure are provided in the circuit board 40 is shown, however, for example, all or at least a part of these transmitting circuit 41, receiving circuit 42, and switching circuit 43 may be provided on the relay board 30.

### Modified Example 3

In the above described embodiment, the battery 60 and the support 13 are exemplified as the shielding portion, however, another electromagnetic shield may be provided.

One of the battery 60 and the support 13 may not function as the shielding portion. For example, even when the support 13 is f formed using a resin member without conductivity, the battery 60 is provided, and thereby, the shielding effect by the electromagnetic shield may be obtained.

### Summary of Present Disclosure

An ultrasonic apparatus according to a first aspect of the present disclosure includes an ultrasonic sensor transmitting and receiving ultrasonic waves and outputting an ultrasonic signal corresponding to the received ultrasonic wave, a circuit coupled to the ultrasonic sensor and processes the ultrasonic signal input from the ultrasonic sensor to generate a reception signal, a wireless communicator coupled to the circuit and converting the reception signal into an electromagnetic wave and transmits the electromagnetic wave to an external device, a casing housing the ultrasonic sensor, the circuit, and the wireless communicator, and a shielding portion disposed between the ultrasonic sensor and the wireless communicator in the casing and shielding the electromagnetic wave.

Accordingly, an electromagnetic shield is provided between the wireless communicator as a noise generation source and the ultrasonic sensor and the circuit through which signal propagation by an analog signal is performed, and thereby, increase of noise due to the electromagnetic wave affecting the ultrasonic signal may be suppressed.

In the ultrasonic apparatus according to the aspect, the shielding portion is preferably a battery supplying power to the ultrasonic sensor, the circuit, and the wireless communicator.

Thereby, the battery supplying power to the respective configurations of the ultrasonic apparatus can be used as the shielding portion, and the configuration of the ultrasonic apparatus can be simplified.

In the ultrasonic apparatus according to the aspect, the battery is preferably covered by a conductive cover.

Accordingly, the conductive cover of the battery serves as an electromagnetic shield, and an influence of the electromagnetic wave generated in the wireless communicator on the circuit and the ultrasonic sensor can be suppressed.

The ultrasonic apparatus according to the aspect further includes a battery supplying power to the ultrasonic sensor, the circuit, and the wireless communicator, and, preferably, the casing includes a support supporting the battery and having conductivity and the shielding portion is the support.

Accordingly, in an ultrasonic apparatus including a battery, a support that supports the battery is usually provided. In the configuration, the support having conductivity is used, and thereby, the support can function as the shielding portion and the configuration of the ultrasonic apparatus can be simplified.

In the ultrasonic apparatus according to the aspect, the casing preferably has conductivity.

Thereby, the ultrasonic sensor and the circuit can be shielded from external electromagnetic waves.

In the ultrasonic apparatus according to the aspect, preferably, the circuit includes a signal generator generating the reception signal from the ultrasonic signal, and the signal generator is disposed at a side closer to the ultrasonic sensor than the shielding portion.

Accordingly, the signal generator generating the reception signal from the ultrasonic signal output from the ultrasonic sensor is disposed at the side closer to the ultrasonic sensor than the shielding portion, and thereby, inconvenience that noise is superimposed on the ultrasonic signal may be suppressed and a proper reception signal may be generated.

In the ultrasonic apparatus according to the aspect, the ultrasonic sensor includes a substrate having a first surface and a second surface and having an opening from the first surface to the second surface, a vibrating plate disposed to cover the first surface of the substrate, and a piezoelectric element disposed in a position overlapping with the opening as seen from a substrate thickness direction from the first surface toward the second surface on a side surface of the vibrating plate opposite to the substrate, and the piezoelectric element includes a first electrode, a piezoelectric layer, and a second electrode stacked along the substrate thickness direction.

Thereby, the thickness of the ultrasonic sensor may be reduced and downsizing of the ultrasonic apparatus may be promoted. In the downsized ultrasonic apparatus, particularly, the distance between the wireless communicator and the circuit is shorter, however, the shielding portion is provided between the wireless communicator and the circuit and the influence of noise can be suppressed.

What is claimed is:

1. An ultrasonic apparatus comprising:
an ultrasonic sensor transmitting and receiving ultrasonic waves and outputting an ultrasonic signal corresponding to the received ultrasonic wave;
a circuit coupled to the ultrasonic sensor and processes the ultrasonic signal input from the ultrasonic sensor to generate a reception signal;
a wireless communicator coupled to the circuit and converting the reception signal into an electromagnetic wave and transmitting the electromagnetic wave to an external device;
a casing housing the ultrasonic sensor, the circuit, and the wireless communicator; and
an electromagnetic shield disposed between the ultrasonic sensor and the wireless communicator in the casing and shielding the electromagnetic wave.

2. The ultrasonic apparatus according to claim 1, wherein
the electromagnetic shield is a battery that supplies power to the ultrasonic sensor, the circuit, and the wireless communicator.

3. The ultrasonic apparatus according to claim 2, wherein
the battery is covered by a conductive cover.

4. The ultrasonic apparatus according to claim 1, further comprising a battery supplying power to the ultrasonic sensor, the circuit, and the wireless communicator, wherein
the casing includes a support supporting the battery and having conductivity, and
the electromagnetic shield is the support.

5. The ultrasonic apparatus according to claim 4, wherein
the support is disposed between the circuit and the wireless communicator.

6. The ultrasonic apparatus according to claim 1, wherein
the casing has conductivity.

7. The ultrasonic apparatus according to claim 1, wherein
the circuit includes a signal generator that generates the reception signal from the ultrasonic signal, and
the signal generator is disposed at a side closer to the ultrasonic sensor than the electromagnetic shield.

8. The ultrasonic apparatus according to claim 1, wherein
the ultrasonic sensor includes:
a substrate having a first surface and a second surface and including an opening from the first surface to the second surface;
a vibrating plate disposed to cover the first surface of the substrate; and
a piezoelectric element disposed in a position overlapping with the opening on a side surface of the vibrating plate opposite to the substrate, wherein
the piezoelectric element includes a first electrode, a piezoelectric layer, and a second electrode stacked along the substrate thickness direction.
